(19) United States
(12) Patent Application Publication
(10) Pub. No.: US 2020/0369560 A1
(43) Pub. Date: Nov. 26, 2020

(54) COVER GLASS AND IN-CELL LIQUID-CRYSTAL DISPLAY DEVICE

(71) Applicant: AGC Inc., Chiyoda-ku (JP)

(72) Inventors: Yosuke TAKEDA, Tokyo (JP); Akio KOIKE, Tokyo (JP); Toru IKEDA, Tokyo (JP); Yasunari SAITO, Tokyo (JP); Makoto FUKAWA, Tokyo (JP); Takaaki MURAKAMI, Tokyo (JP)

(73) Assignee: AGC Inc., Chiyoda-ku (JP)

(21) Appl. No.: 16/991,301

(22) Filed: Aug. 12, 2020

Related U.S. Application Data
(63) Continuation of application No. PCT/JP2019/005148, filed on Feb. 13, 2019.

(30) Foreign Application Priority Data
Feb. 16, 2018 (JP) 2018-026237

(51) Int. Cl. C03C 4/18; C03C 21/00; C03C 17/42; C03C 3/097; C03C 3/085; C03C 3/087; C03C 3/091

(52) U.S. Cl. CPC C03C 4/18; C03C 21/002; C03C 17/42; C03C 3/097; C03C 3/085; C03C 2204/00; C03C 3/091; C03C 2218/112; C03C 2218/151; C03C 2217/75; C03C 2217/734; C03C 3/087

(57) ABSTRACT

A cover glass includes a chemically strengthened glass including a first main surface having an area of 12,000 mm² or larger and a second main surface, and an anti-fingerprint treated layer provided on or above the first main surface. The chemically strengthened glass has a depth of compressive stress layer DOL of 20 μm or larger, has a tensile stress layer having a P₂O₅ content of 2 mol % or less, and has A×B of 135 or larger, provided that, among oxide components constituting the tensile stress layer, a total concentration of Li₂, Na₂O, and K₂O is A mol % and a concentration of Al₂O₃ is B mol %. The anti-fingerprint treated layer includes a surface having a frictional electrification amount, as determined by Method D described in JIS L1094:2014, of 0 kV or less and −1.5 kV or more.

### TECHNICAL FIELD

The present invention relates to a cover glass and an in-cell liquid-crystal display device.

### BACKGROUND ART

Some electronic appliances having a liquid-crystal display device, such as automotive navigation systems for mounting on vehicles, are equipped with a touch function. The touch function herein is a function whereby information is inputted by an operator by bringing a finger into contact with or close to the surface (cover glass) of the display device.

Among structures for rendering the touch function possible is an outside type (out-cell) which includes a liquid-crystal display device and a touch panel attached thereto.

The outside type is excellent in terms of yield because even in the case where either the liquid-crystal display or the touch panel is a failure, the remainder is usable. However, there is a problem in that this type has an increased thickness and an increased weight.

An on-cell liquid-crystal display device has come to be used, in which a touch panel has been sandwiched between the liquid-crystal element and polarizer of the liquid-crystal display device.

Furthermore, an in-cell liquid-crystal display device, in which an element with a touch function is embedded in a liquid-crystal element, has been developed as a structure which is thinner and more lightweight than the on-cell type.

Meanwhile, in-cell liquid-crystal display devices (in particular, IPS liquid-crystal display devices) have a problem in that the liquid-crystal display screen partly opacifies when touched with a finger. This is because the liquid-crystal element in the in-cell liquid-crystal display device is prone to be electrostatically charged because the touch panel has been disposed not on the operator side of the liquid-crystal element, in contrast to the outside type and the on-cell type, in which the touch panel lies on the operator side of the liquid-crystal element to contribute to charge neutralization. In particular, there are cases where layers for enhancing impact resistance and antifouling properties are formed on the surface of a cover glass, and if these layers are prone to be charged, the opacification is more apt to occur.

A structure of an in-cell liquid-crystal display device has been proposed in which the opacification is prevented by disposing an electroconductive layer on the operator side of the liquid-crystal display element to thereby dissipate electrostatic charges (Patent Document 1).

### CITATION LIST

### Patent Document

Patent Document 1: International Publication WO 2014/069377

### SUMMARY OF INVENTION

### Technical Problems

However, the structure proposed in Patent Document 1 has a problem in that the disposition of the electroconductive layer results in an increase in thickness. There is another problem in that the disposition thereof results in an increase in the number of steps for producing the display device.

The present invention has been achieved in view of those problems, and an object, is to provide: a cover glass which can prevent opacification without necessitating an increase in display-device thickness or in the number of production steps and which has excellent impact resistance; and an in-cell liquid-crystal display device (in particular, an IPS liquid-crystal display device).

### Solution to the Problems

The cover glass of the present invention includes a chemically strengthened glass including a first main surface having an area of 12,000 mm² or larger and a second main surface; and an anti-fingerprint treated layer provided on or above the first main surface, wherein the chemically strengthened glass has a depth of compressive stress layer DOL of 20 μm or larger, has a tensile stress layer having a P₂O₅ content of 2 mol % or less, and has A×B of 135 or larger, provided that, among oxide components constituting the tensile stress layer, a total concentration of Li₂, Na₂O, and K₂O is A mol % and a concentration of Al₂O₃ is B mol %, and the anti-fingerprint treated layer includes a surface having a frictional electrification amount, as determined by Method D described in JIS L1094:2014, of 0 kV or less and −1.5 kV or more.

Alternatively, the cover glass of the present invention includes a chemically strengthened glass including a first main surface having an area of 12,000 mm² or larger and a second main surface; and an anti-fingerprint treated layer provided on or above the first main surface, wherein the chemically strengthened glass has a depth of compressive stress layer DOL of 20 μm or larger, has a tensile stress layer having a P₂O₅ content of 5 mass % or less, and has C×D of 240 or larger, provided that, among oxide components constituting the tensile stress layer, a total concentration of Li₂O, Na₂O, and K₂O is C mass % and a concentration of Al₂O₃ is D mass %, and the anti-fingerprint treated layer includes a surface having a frictional electrification amount, as determined by Method D described in JIS L1094:2014, of 0 kV or less and −1.5 kV or more.

Since the P₂O₅ content is not higher than a given value, the cover glass of the present invention is less apt to have surface defects attributable to P and is less apt to suffer local electrification due to surface defects. Because of this, the cover glass of the present invention is less apt to suffer frictional electrification even when fingers of the user, etc. come into contact with the surface. The cover glass, after having been incorporated into display devices, can prevent the opacification due to electrostatic charges.

The cover glass of the present invention contains at least a certain amount of Li₂O, Na₂O, and K₂O, which do not contribute to the formation of glass network and which have high mobility and combine with electrostatic charges to perform charge neutralization. Because of this, the cover glass of the present invention is less apt to suffer frictional electrification even when fingers of the user, etc. come into contact with the surface. The cover glass, after having been incorporated into display devices, can prevent the opacification due to electrostatic charges.

The cover glass of the present invention contains at least a certain amount of Al₂O₃, which contributes to network formation and which is close to Li₂O, Na₂O, and K₂O and enables Li₂, Na₂O, and K₂O to come into the network to enlarge the distance. Hence, the Li₂, Na₂O, and K₂O are more movable, and the cover glass of the present invention is less apt to suffer frictional electrification even when fingers of the user, etc. come into contact with the surface. The cover glass, after having been incorporated into display devices, can prevent the opacification due to electrostatic charges.

Furthermore, the cover glass of the present invention by itself is inhibited from being frictionally charged and there is hence no need of disposing an electroconductive layer. Even when having a structure including a main surface with an area as large as 12,000 mm² or larger, the cover glass can prevent opacification without increasing the thickness of the display device or the number of steps for production.

Moreover, the cover glass of the present invention has a depth of compressive stress layer DOL of 20 μm or larger. Because of this, in the case where an external shock is given thereto, a deformation due to the shock is less apt to be transmitted to the tensile stress layer, resulting in enhanced impact resistance.

It is preferable that the cover glass of the present invention is one in which the first main surface and the second main surface each have an area of 18,000 mm² or larger.

Since the surface of the anti-fingerprint treated layer in the cover glasses of the present invention has a frictional electrification amount of 0 kV or less and −1.5 kV or more, the cover glass in which the first and second main surfaces have an area as large as 18,000 mm² or larger is less apt to suffer frictional electrification even when fingers of the user, etc. come into contact with the surface. The cover glass, after having been incorporated into display devices, can prevent the opacification due to electrostatic charges.

It is preferable that the cover glass of the present invention is one in which the first main surface and the second main surface have an area of 26,000 mm² or larger and the surface of the anti-fingerprint treated layer has a frictional electrification amount, as determined by Method D described in JIS L1094:2014, of 0 kV or less and −0.5 kV or more.

In this case, since the surface of the anti-fingerprint treated layer has a frictional electrification amount, as determined by Method D, of 0 kV or less and −0.5 kV or more, the cover glass in which the first and second main surfaces have an area as large as 26,000 mm² or above is less apt to suffer frictional electrification even when fingers of the user, etc. come into contact with the surface. The cover glass, after having been incorporated into display devices, can prevent the opacification due to electrostatic charges.

It is preferable that the cover glass of the present invention includes at least one of an antiglare functional layer and an antireflection layer between the chemically strengthened glass and the anti-fingerprint treated layer.

In the case where the cover glass of the present invention includes an antiglare functional layer, it is possible to scatter incident light to diminish the reflection of incident light in the surface. In the case where the cover glass of the present invention includes an antireflection layer, it is possible to prevent incident light from being reflected and to prevent the reflection of incident light in the surface.

It is preferable that the cover glass of the present invention includes a light-shielding layer provided on or above the second main surface.

In the case where the cover glass including a light-shielding layer provided on the second main surface has been incorporated into a display device, it is possible to hide wiring lines disposed on the display device side and to hide illuminating light of the backlight and prevent the illuminating light from leaking through the periphery of the display device.

In the case where the cover glass of the present invention includes a light-shielding layer provided on the second main surface, it is preferable that the light-shielding layer has an opening and that an infrared-transmitting layer having a higher infrared transmittance than the light-shielding layer is provided to the opening.

In the case where an infrared-transmitting layer has been provided to the light-shielding layer and this cover glass has been incorporated into a display device having an infrared sensor, then the infrared sensor can be disposed on the back side of the light-shielding layer and the infrared-transmitting layer can be unnoticeable.

It is preferable that in the cover glass of the present invention, the chemically strengthened glass is a bent glass.

In the case where the chemically strengthened glass is a bent glass, attachment of this cover glass to a mating member does not result in a decrease in attachment accuracy even when the mating member has a bent shape.

The in-cell liquid-crystal display device of the present invention includes any of the cover glasses shown above.

According to the present invention, an in-cell liquid-crystal display device protected by a cover glass is obtained.

### BRIEF DESCRIPTION OF DRAWINGS

FIG. 1 is a cross-sectional view of a cover glass according to an embodiment of the present invention.

FIG. 2 is a cross-sectional view of a cover glass according to a modification example.

FIG. 3 is a cross-sectional view of a cover glass according to a modification example.

FIG. 4A is a perspective view of a cover glass according to a modification example.

FIG. 4B is a cross-sectional view taken on B-B of FIG. 4A.

FIG. 5 is a cross-sectional view of a cover glass according to a modification example.

FIG. 6 is a cross-sectional view of a portion of a display device equipped with a cover glass according to an embodiment of the present invention.

### DESCRIPTION OF EMBODIMENTS

One embodiment of the present invention is explained below by reference to the drawings.

In this description, the expression “a to b” used for indicating a range means the range of from a to b, in which the lower-limit value a and the upper-limit value b are included.

### [Configuration of the Cover Glass]

First, the configuration of the cover glass is explained.

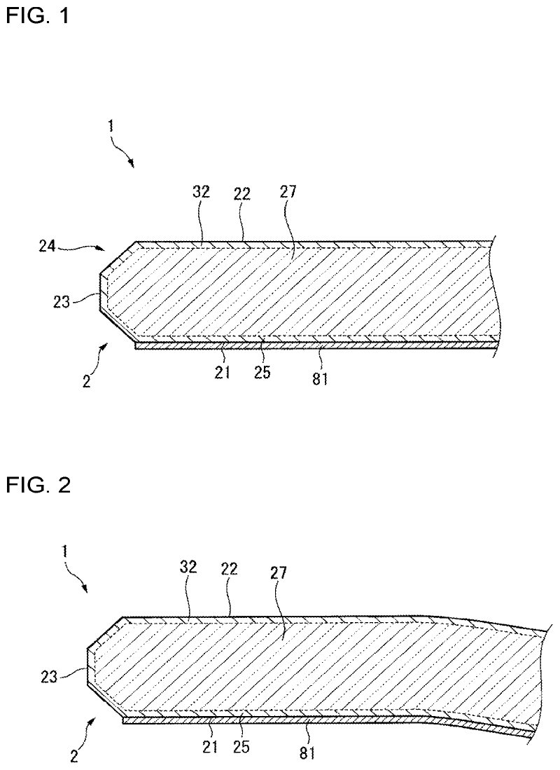

The cover glass 1 shown in FIG. 1 includes a chemically strengthened glass 2 and an anti-fingerprint treated layer 81.

The chemically strengthened glass 2 is a rectangular plate in a plan view and is a chemically strengthened glass which transmits visible light. As FIG. 1 shows, the chemically strengthened glass 2 has a first main surface 21, a second main surface 22, and edge surfaces 23. The edge surfaces 23 include chamfers 24.

The chemically strengthened glass 2 includes compressive stress layers 25 and 32 and a tensile stress layer 27. The compressive stress layers 25 and 32 are layers on which compressive stress is being imposed (layers having a compressive stress of 0 MPa or larger). The compressive stress layer 25 is provided in the surface on the side where the first main surface 21 lies, and the compressive stress layer 32 is provided in the surface on the side where the second main surface 22 lies.

The tensile stress layer 27 is a layer on which tensile stress is being imposed (layer having a compressive stress less than 0 MPa). The tensile stress layer 27 is provided between the compressive stress layer 25 and the compressive stress layer 32.

The first main surface 21 of the chemically strengthened glass 2 has an area of 12,000 mm² or larger. This renders the cover glass 1 according to this embodiment applicable to appliances necessitating large-area cover glasses, such as display appliances for mounting on vehicles.

The compressive stress layers 25 and 32 of the chemically strengthened glass 2 have a depth DOL (depth of layer) of 20 μm or larger. Since the DOL is 20 μm or larger, a deformation due to an external shock given to the chemically strengthened glass 2 is less apt to be transmitted to the tensile stress layer, resulting in enhanced impact resistance.

The DOL is more preferably 30 μm to 250 μm.

Theoretically, “DOL” means the depth from the surface to a position where the compressive stress has decreased to 0 MPa, along the sheet thickness direction. DOL can be determined by analyzing the glass for depth-direction alkali ion concentration with, for example, an EPMA (electron probe micro analyzer) (in this example, analysis for determining the concentration of ions diffused by chemical strengthening) and regarding the measured ion diffusion depth as the DOL. Alternatively, DOL can be measured using a surface stress meter (e.g., FSM-6000, manufactured by Orihara Industrial Co., Ltd.) or the like.

The tensile stress layer 27 of the chemically strengthened glass 2 has a P₂O₅ content of 2 mol % or less. Since the P₂O₅ content of the tensile stress layer 27 is 2 mol % or less, the cover glass 1 is less apt to have surface defects attributable to P and is less apt to suffer local electrification due to surface defects. In the case of limiting P₂O₅ content in mass %, the content is about 5 mass % or less.

Provided that, among oxide components constituting the tensile stress layer 27 of the chemically strengthened glass 2, a total concentration of Li₂O, Na₂O, and K₂O is A mol % and a concentration of Al₂O₃ is B mol %, A×B is 135 or larger. More preferably, the A×B is 150 to 250.

In the case of expressing A×B in terms of mass, the total concentration of Li₂O, Na₂O, and K₂O is C mass % and the concentration of Al₂O₃ is D mass % among the oxide components constituting the tensile stress layer 27 of the chemically strengthened glass 2. In this case, the A×B is expressed by C×D, and the C×D is preferably 240 or larger, more preferably 250 to 300, although it depends on the molar ratio of each component to the sum of Li₂O, Na₂O, and K₂O.

The reasons are as follows.

The components of a glass can be divided roughly into components contributing to the formation of the glass network (network formers) and components not contributing to the network formation.

From the standpoint of preventing static buildup, it is preferable that the components not contributing to network formation are contained in large amounts. This is because the components not contributing to network formation have higher mobility than the components contributing to network formation and are hence thought to combine with electrostatic charges to perform charge neutralization. Since Li₂, Na₂O, and K₂O in the glass are components not contributing to network formation, it is preferable that the content of these components is high. Namely, the A and the C are preferably large values.

Meanwhile, Al₂O₃ serves as both a component contributing to network formation and a component not contributing thereto. In the case of Al₂O₃ contributing to network formation, the Al₂O₃ tends to be close to Li₂O, Na₂O, and K₂O. In the case where Al₂O₃ is close to Li₂O, Na₂O, and K₂O, the Li₂O, Na₂O, and K₂O come among network-forming components to enlarge the distance between networks. The enlarged distance between the networks enables the components not contributing to network formation to readily move between the networks and have increased mobility, and is hence preferred. These are the reasons for limiting A×B.

Although frictional electrification is a phenomenon occurring in the surface compressive stress layer 25, a preferred composition of the tensile stress layer 27 is limited for the following reasons.

Frictional electrification is affected by the network of the glass and it is hence essentially desirable to limit the structure of the glass. However, since glasses are amorphous and there are cases where it is difficult to specify the structure, it is preferred to limit a glass by composition. Meanwhile, since the compressive stress layer 25 has undergone ion exchange by chemical strengthening, the compressive stress layer 25 differs in composition from the tensile stress layer 27 although having the same glass network structure. Supposing that a glass having the same composition as the compressive stress layer 25 is produced without chemical strengthening, this glass undesirably has a different network structure. It is hence difficult to specify the structure of the compressive stress layer 25 from the composition of the compressive stress layer 25. Consequently, the composition of the tensile stress layer 27 is specified to thereby specify the structure of the tensile stress layer 27, and the fact that the tensile stress layer 27 and the compressive stress layer 25 do not change in structure even through chemical strengthening is utilized to specify the structure of the compressive stress layer 25 from the composition of the tensile stress layer 27.

The value of A is preferably 14.5 or larger. This is because Li₂O, Na₂O, and K₂O are components not contributing to network formation in the glass. The value of A is more preferably 15 to 20.

The value of C is preferably 11 or larger, more preferably 12 to 20, although it depends on the molar ratio of each component to the sum of Li₂O, Na₂O, and K₂O.

The total concentration of SiO₂, Al₂O₃, B₂O₃, and P₂O₅, among the oxide components constituting the tensile stress layer 27 of the chemically strengthened glass 2, is 81 mol % or less. This is because these elements are components contributing to glass network formation and a lower content thereof results in a higher content of components contributing to charge neutralization. Another reason is that a lower content of those components results in an enlarged distance between network-forming components to heighten the mobility of components not contributing to network formation.

Although frictional electrification is a phenomenon occurring in the surface compressive stress layer 25, a preferred composition of the tensile stress layer 27 has been limited for the same reasons as those for limiting A×B.

The total content of those components is more preferably 15 to 20 mol %.

In the case where the total concentration of SiO₂, Al₂O₃, B₂O₃, and P₂O₅ is expressed in terms of mass %, the total content of these components is preferably 81 mass % or less, more preferably 70 to 80 mass %, although it depends on the molar ratio of each component to the sum of these.

More specifically, the tensile stress layer 27 preferably has a glass composition including, as represented by mass percentage based on oxides, 55% to 68% of SiO₂, 10% to 25% of Al₂O₃, 0% to 5% of B₂O₃, 0% to 5% of P₂O₅, 0% to 8% of Li₂O, 1% to 20% of Na₂O, 0.1% to 10% of K₂O, 0% to 10% of MgO, 0% to 5% of CaO, 0% to 5% of SrO, 0% to 5% of BaO, 0% to 5% of ZnO, 0% to 1% of TiO₂, ZrO₂, and 0.005% to 0.1% of Fe₂O₃.

The composition of the tensile stress layer 27 can be determined by known composition analysis methods such as chemical analysis, absorptiometry, atomic absorption analysis, X-ray fluorescent spectroscopy, etc. Although any desired portion of the tensile stress layer 27 may be examined, it is preferred to examine a portion lying at the thickness-direction center of the glass substrate and at the center of gravity in a plan view.

The components in the preferred glass composition of the tensile stress layer 27 shown above are explained below. In the following explanations on the glass composition, each content in % is the content as represented by mass percentage based on oxides unless otherwise indicated.

SiO₂ is a component which constitutes the network of the glass. SiO₂ is also a component which enhances the chemical durability and which inhibits the glass surfaces in the state of having scratches (indentations) therein from cracking. From the standpoint of inhibiting cracking, the content of SiO₂ is preferably 55% or higher, more preferably 56% or higher, still more preferably 56.5% or higher, especially preferably 58% or higher. Meanwhile, from the standpoints of improving the mobility of elements contributing to charge neutralization in the glass and improving the meltability in glass production steps, the content of SiO₂ is preferably 68% or less, more preferably 65% or less, still more preferably 63% or less, especially preferably 61% or less.

Al₂O₃ is a component effective in improving the suitability for ion exchange for chemical strengthening treatment to attain an increased surface compressive stress CS after chemical strengthening. Al₂O₃ is effective also in improving the fracture toughness of the glass. Al₂O₃ is also a component which heightens the Tg of the glass and heightens the Young's modulus. Furthermore, Al₂O₃ has the effect of improving the mobility of elements contributing to charge neutralization in the glass. From the standpoint of enhancing these properties, the content of Al₂O₃ is preferably 10% or higher, more preferably 12% or higher. From the standpoint of enhancing the fracture toughness, the content of Al₂O₃ is more preferably 14% or higher. Meanwhile, from the standpoint of increasing the content of elements contributing to charge neutralization in the glass and from the standpoints of maintaining the acid resistance of the glass and lowering the devitrification temperature, the content of Al₂O₃ is preferably 25% or less, more preferably 23% or less.

Al₂O₃ is also a constituent component of lithium aluminosilicate crystals. From the standpoint of inhibiting crystal precipitation during bending, the content of Al₂O₃ is preferably 22% or less, more preferably 20% or less, still more preferably 19% or less.

B₂O₃ is a component which improves the meltability of the glass. B₂O₃ is also a component which improves the chipping resistance of the glass. Although B₂O₃ is not essential, in the case where B₂O₃ is contained, the content of B₂O₃ is preferably 0.1% or higher, more preferably 0.5% or higher, still more preferably 1% or higher, from the standpoint of improving the meltability. Meanwhile, from the standpoint of improving the mobility of elements contributing to charge neutralization in the glass and from the standpoint of preventing the occurrence of striae during melting, the content of B₂O₃ is preferably 5% or less, more preferably 4% or less, still more preferably 3% or less, especially preferably 2.5% or less.

P₂O₅ should be 5% or less (about 2 mol % or less) from the standpoint of preventing local electrification. P₂O₅ may be contained to improve the suitability for ion exchange for chemical strengthening treatment and the chipping resistance. In the case where P₂O₅ is contained, the content of P₂O₅ is preferably 0.1% or higher, more preferably 0.5% or higher, still more preferably 1% or higher. Meanwhile, in the case where P₂O₅ is contained, the content of P₂O₅ needs to be 5% or less (about 2 mol % or less) from the standpoints of ensuring acid resistance and preventing electrification, and is preferably 4% or less, more preferably 3% or less, still more preferably 2.5% or less, yet still more preferably 1% or less, especially preferably 0.5% or less.

Li₂O is a component which forms a surface compressive stress layer in chemical strengthening treatments with sodium salts, e.g., sodium nitrate. Li₂O is also a substance which contributes to charge neutralization in the glass.

From the standpoint of obtaining the effects of the inclusion thereof, the content of Li₂O is preferably 0.1% or higher, more preferably 1% or higher, still more preferably 2% or higher. Meanwhile, from the standpoint of ensuring weatherability, the content of Li₂O is preferably 8% or less. From the standpoint of inhibiting crystal precipitation during bending, the content of Li₂O is preferably 7% or less, more preferably 5% or less.

Na₂O is a component which forms a surface compressive stress layer in chemical strengthening treatments with potassium salts and is a component which improves the meltability of the glass. Na₂O is also a substance which contributes to charge neutralization in the glass.

From the standpoint of obtaining these effects, the content of Na₂O is preferably 1% or higher, more preferably 1.5% or higher, still more preferably 2% or higher. Meanwhile, from the standpoint of improving the surface compressive stress CS, the content of Na₂O is preferably 20% or less, more preferably 16% or less, still more preferably 14% or less, especially preferably 8% or less.

K₂O is a substance which improves the meltability of the glass. K₂O is also a substance which contributes to the charge neutralization in the glass. In the case where K₂O is contained, the content of K₂O is preferably 0.1% or higher, more preferably 0.5% or higher. Meanwhile, from the standpoint of ensuring the fracture resistance of the chemically strengthened glass 2, the content of K₂O is preferably 8% or less, more preferably 5% or less, still more preferably 3% or less.

MgO, although not essential, enhances the surface compressive stress CS of the chemically strengthened glass 2. It is hence preferable that MgO is contained. MgO further has the effect of improving the fracture toughness. Consequently, the content of MgO is preferably 0.1% or higher, more preferably 0.5% or higher, still more preferably 2% or higher. Meanwhile, from the standpoint of inhibiting devitrification during glass melting, the content of MgO is preferably 10% or less, more preferably 8% or less, still more preferably 6% or less.

CaO, although not essential, is a component improving the meltability of the glass and may be contained. In the case where CaO is contained, the content of CaO is preferably 0.05% or higher, more preferably 0.1% or higher, still more preferably 0.15% or higher. Meanwhile, from the standpoint of ensuring suitability for ion exchange for chemical strengthening treatment, the content of CaO is preferably 3.5% or less, more preferably 2.0% or less, still more preferably 1.5% or less.

SrO, although not essential, is a component improving the meltability of the glass and may be contained. In the case where SrO is contained, the content of SrO is preferably 0.05% or higher, more preferably 0.1% or higher, still more preferably 0.5% or higher. Meanwhile, from the standpoint of enhancing the suitability for ion exchange for chemical strengthening treatment, the content of SrO is preferably 5% or less, more preferably 3.5% or less, still more preferably 2% or less, and it is especially preferable that substantially no SrO is contained.

BaO, although not essential, is a component improving the meltability of the glass and may be contained. In the case where BaO is contained, the content of BaO is preferably 0.1% or higher, more preferably 0.5% or higher, still more preferably 1% or higher. Meanwhile, from the standpoint of enhancing the suitability for ion exchange for chemical strengthening treatment, the content of BaO is preferably 5% or less, more preferably 3% or less, still more preferably 2% or less, and it is yet still more preferable that substantially no BaO is contained.

ZnO is a component which improves the meltability of the glass, and may be contained. In the case where ZnO is contained, the content of ZnO is preferably 0.05% or higher, more preferably 0.1% or higher. Meanwhile, in the case where the content of ZnO is 5% or less, the glass can have enhanced weatherability. Such ZnO contents are hence preferred. The content of ZnO is more preferably 3% or less, still more preferably 1% or less, and it is especially preferable that substantially no ZnO is contained.

TiO₂ is a component which inhibits the glass from being discolored by solarization, and may be contained. In the case where TiO₂ is contained, the content of TiO₂ is preferably 0.01% or higher, more preferably 0.03% or higher, still more preferably 0.05% or higher, especially preferably 0.1% or higher. Meanwhile, from the standpoint of inhibiting devitrification during melting, the content of TiO₂ is preferably 1% or less, more preferably 0.5% or less, still more preferably 0.2% or less.

ZrO₂ is a component which enhances the surface compressive stress CS through ion exchange in a chemical strengthening treatment, and may be contained. In the case where ZrO₂ is contained, the content of ZrO₂ is preferably 0.1% or higher, more preferably 0.5% or higher, still more preferably 1% or higher. Meanwhile, from the standpoint of inhibiting devitrification during melting to heighten the quality of the chemically strengthened glass 2, the content of ZrO₂ is preferably 5% or less, more preferably 3% or less, especially preferably 2.5% or less.

Fe₂O₃ absorbs heat rays and hence has the effect of improving the meltability of the glass. It is preferable that Fe₂O₃ is contained in the case of mass-producing the glass using a large melting furnace. The content thereof in this case is preferably 0.005% or higher, more preferably 0.006% or higher, still more preferably 0.007% or higher. Meanwhile, too high contents thereof result in a coloration. Consequently, from the standpoint of enhancing the transparency of the glass, the content of Fe₂O₃ is preferably 0.1% or less, more preferably 0.05% or less, still more preferably 0.02% or less, especially preferably 0.015% or less.

In the explanation given above, the iron oxides present in the glass are all taken as Fe₂O₃. Actually, however, Fe(III), which is in an oxidized state, usually coexists with Fe(II), which is in a reduced state. Of these, Fe(III) causes a yellow coloration and Fe(II) causes a blue coloration. A balance therebetween causes a green coloration to the glass.

The chemically strengthened glass 2 may contain Y₂O₃, La₂O₃, and Nb₂O₅. In the case where these components are contained, the total content of these components is preferably 0.01% or higher, more preferably 0.05% or higher, still more preferably 0.1% or higher, especially preferably 0.15% or higher, most preferably 1% or higher. Meanwhile, in case where the content of Y₂O₃, La₂O₃, and Nb₂O₅ is too high, the glass is prone to devitrify during melting and there is the possibility of resulting in a decrease in the quality of the chemically strengthened glass 2. Consequently, the total content of these components is preferably 7% or less. The total content of Y₂O₃, La₂O₃, and Nb₂O₅ is more preferably 6% or less, still more preferably 5% or less, especially preferably 4% or less, most preferably 3.5% or less.

Ta₂O₅ and Gd₂O₃ may be contained in a small amount to improve the fracture resistance of the chemically strengthened glass 2. However, since the inclusion of these components heightens the refractive index and reflectance, the total content thereof is preferably 5% or less, more preferably 2% or less. It is still more preferable that substantially neither of these is contained.

Moreover, in the case of coloring the glass, coloring ingredients may be added so long as the desired chemically enhanced properties are not impaired thereby. Suitable examples of the coloring ingredients include CO₃O₄, MnO₂, NiO, CuO, Cr₂O₃, V₂O₅, Bi₂O₃, SeO₂, CeO₂, Er₂O₃, and Nd₂O₃.

The total content of such coloring ingredients is preferably 7% or less, because such contents are less apt to arouse problems, e.g., devitrification. The content thereof is preferably 5% or less, more preferably 3% or less, still more preferably 2% or less. In the case where the visible-light transmittance of the glass is preferential, it is preferable that these ingredients are substantially not contained.

The glass may suitably contain SO₃, a chloride, a fluoride, or the like as a refining agent for use in glass melting. It is preferable that the glass contains no As₂O₃ because it imposes a heavy environmental burden. In the case where Sb₂O₃ is contained, the content thereof is preferably 1% or less, more preferably 0.5% or less. It is most preferable that the glass contains no Sb₂O₃.

The chemically strengthened glass 2 has a surface compressive stress CS of preferably 300 MPa to 1,500 MPa.

In the case where the CS thereof is 300 MPa or larger, this chemically strengthened glass 2 can retain flexural strength required of cover glasses. In the case where the CS thereof is 1,500 MPa or less, this chemically strengthened glass 2 can be prevented from shattering upon breakage. The CS thereof is more preferably 800 MPa to 1,200 MPa.

The term “surface compressive stress CS” herein means the compressive stress of an outermost surface of the glass. The surface compressive stress CS can be measured with a surface stress meter (e.g., FSM-6000, manufactured by Orihara Industrial Co., Ltd.) or the like.

The chemically strengthened glass 2 has an internal tensile stress CT of preferably 20 MPa to 100 MPa.

In the case where the CT thereof is 20 MPa or larger, a state can be achieved in which compressive stress having an appropriate stress value exists as reaction down to an appropriate depth. In the case where the CT thereof is 100 MPa or less, this chemically strengthened glass 2 can be prevented from shattering upon breakage. The CT thereof is more preferably 40 MPa to 85 MPa.

The internal tensile stress CT is approximated using the relational expression CT=(CS×DOL)/(t−2×DOL), where t is the thickness of the cover glass 1.

The anti-fingerprint treated layer 81 is a layer for rendering the first main surface 21 less apt to suffer adhesion of fouling substances, such as fingerprints, sebaceous matter, and sweat, thereto upon contact with human fingers.

A material for constituting the anti-fingerprint treated layer 81 can be suitably selected from fluorine-containing organic compounds and the like which are capable of imparting antifouling properties, water repellency, and oil repellency. Specific examples thereof include fluorine-containing organosilicon compounds and fluorine-containing hydrolyzable silicon compounds. Any fluorine-containing organic compounds capable of imparting antifouling properties, water repellency, and oil repellency can be used without particular limitations.

A coating film of a fluorine-containing organosilicon compound, which constitutes the anti-fingerprint treated layer 81, is formed on the first main surface 21 of the chemically strengthened glass 2. Alternatively, in the case where an antiglare layer is formed on the first main surface 21 and an antireflection layer is formed on the surface thereof, it is preferable that the anti-fingerprint treated layer 81 is formed on the surface of the antireflection layer. In the case where the first main surface 21 of the chemically strengthened glass 2 is subjected to a surface treatment such as an antiglare treatment and no antireflection layer is formed, it is preferable that a coating film of a fluorine-containing organosilicon compound is formed directly on the treated surface.

For forming the coating film of a fluorine-containing organosilicon compound, any fluorine-containing hydrolyzable silicon compound can be used without particular limitations so long as the obtained coating film of a fluorine-containing organosilicon compound has antifouling properties including water repellency and oil repellency. Specific examples of the compound include fluorine-containing hydrolyzable silicon compounds each having one or more groups selected from the group consisting of perfluoropolyether groups, perfluoroalkylene groups, and perfluoroalkyl groups.

Specifically, examples of materials usable for forming the anti-fingerprint treated layer 81 include the following commercial products: “KP-801” (trade name; manufactured by Shin-Etsu Chemical Co., Ltd.), “X-71” (trade name; manufactured by Shin-Etsu Chemical Co., Ltd.), “KY-130” (trade name; manufactured by Shin-Etsu Chemical Co., Ltd.), “KY-178” (trade name; manufactured by Shin-Etsu Chemical Co., Ltd.), “KY-185” (trade name; manufactured by Shin-Etsu Chemical Co., Ltd.), “KY-195” (trade name; manufactured by Shin-Etsu Chemical Co., Ltd.), and “OPTOOL (registered trademark) DSX” (trade name; manufactured by Daikin Industries, Ltd.). It is also possible to add an oil or an antistatic agent to any of these commercial products before use.

The anti-fingerprint treated layer 81 is not particularly limited in its layer thickness. However, the thickness thereof is preferably 2 nm to 20 nm, more preferably 2 nm to 15 nm, still more preferably 3 nm to 10 nm. In the case where the layer thickness is 2 nm or larger, the surface of the antireflection layer is in the state of being evenly covered with the anti-fingerprint treated layer 81 and has practical abrasion resistance. In the case where the layer thickness is 20 nm or less, the chemically strengthened glass 2 in the state of being coated with the anti-fingerprint treated layer 81 has satisfactory optical properties, e.g. luminous reflectance and haze.

The surface of the anti-fingerprint treated layer 81 of the cover glass 1 has a frictional electrification amount of 0 kV or less and −1.5 kV or more. The term “frictional electrification amount” herein means a frictional electrification amount determined by Method D (frictional-electrification attenuation measuring method) described in JIS L1094:2014. Although fluorochemical anti-fingerprint treated layers are negatively charged in that evaluation method, such anti-fingerprint treated layers having a frictional electrification amount of −1.5 kV or more can be prevented from being charged. The frictional electrification amount is more preferably 0 kV to −1 kV.

In the case where the area of the first main surface 21 is 18,000 mm² or larger, the frictional electrification amount is preferably 0 kV to −1 kV This is because there is a tendency in use as a touch panel that the larger the area of the first main surface 21, the longer the time period of contact with a finger and the longer the distance over which the finger moves, and because the electrification amount increases accordingly.

In the case where the area of the first main surface 21 is 26,000 mm² or larger, the frictional electrification amount is preferably 0 kV to −0.5 kV The reason is the same as in the case where the area is 18,000 mm² or larger.

As a frictional electrification amount, use can be made of an index determined by a method other than Method D.

Specifically, a static-charge visualization monitor (HSK-V5000B, manufactured by Hanwa Electrical Ind. Co., Ltd.) is disposed at a distance of 35 mm from a surface of a glass sample, the glass sample surface is rubbed with a cloth, and the resultant electrification amount is measured. As the cloth, unbleached muslin No. 3 is used. Six strips of the unbleached muslin are attached to a rectangular parallelepiped jig so that the cloth is in contact with the glass in an area of 20×20 mm, and the cloth is rubbed against the glass sample surface by reciprocating the jig thereon five times under a load of about 350 g. The cloth is rubbed over a distance of 4 to 14 cm at a speed of one reciprocation per second. Just after termination of the rubbing, the initial maximum electrification amount is measured. The reason why this method is used is that in a touch panel employing a large-area cover glass 1, the finger in contact with the cover glass 1 moves over a longer distance on average and, hence, a test method in which the contact time and the friction distance are long more reflects electrification during actual use. This method and the JIS Method D differ in sensor, sample-to-sensor distance, area of the portion rubbed with cloth, rubbing method, jig to which the cloth is attached, etc., and the electrification amounts respectively measured by the two methods cannot be compared with each other as such.

The above is an explanation of the configuration of the cover glass 1.

### [Process for Producing Cover Glass 1]

Next, an example of processes for producing the cover glass 1 is explained.

First, a chemically strengthened glass 2 is produced in the following manner.

The chemically strengthened glass 2 is produced by subjecting a glass for chemical strengthening, which has been produced by a common glass production method, to a chemical strengthening treatment.

The chemical strengthening treatment is a treatment in which an ion exchange treatment is given to the surfaces of the glass to form a surface layer having compressive stress therein. Specifically, the ion exchange treatment is conducted at a temperature not higher than the glass transition temperature of the glass for chemical strengthening to replace metal ions having a small ionic radius (typically, Li ions or Na ions) present in the vicinity of the glass surfaces with ions having a larger ionic radius (typically, Na or K ions for replacing Li ions, or K ions for replacing Na ions).

The chemically strengthened glass 2 can be produced by giving the chemical strengthening treatment to a glass for chemical strengthening which has the composition of the tensile stress layer 27 described hereinabove.

The production method shown below is an example of the case of producing a plate-shaped chemically strengthened glass.

First, raw materials for glass are mixed and the mixture is heated and melted in a glass melting furnace. Thereafter, the glass is homogenized by bubbling, stirring, addition of a refining agent, etc., formed into a glass sheet having a given thickness by a conventionally known forming method, and gradually cooled. Alternatively, the homogenized glass may be molded to obtain a block-shaped glass and this block is gradually cooled and then cut to obtain a plate-shaped glass.

Examples of methods for forming the glass into a sheet shape include a float process, pressing, a fusion process, and a downdraw process. The float process is preferred especially in the case of producing large glass sheets. Also preferred are continuous forming methods other than the float process, such as, for example, the fusion process and the downdraw process.

Thereafter, the formed glass is cut into a given size and chamfered. It is preferred to conduct the chamfering so as to result in chamfers 24 which, in a plan view, have a dimension of 0.05 mm to 0.5 mm.

Next, the glass sheet is chemically strengthened by performing an ion exchange treatment about once or twice (about one or two stages), thereby forming compressive stress layers 25 and 32 and a tensile stress layer 27.

In the chemical strengthening step, the glass to be treated is brought into contact with a molten salt (e.g., a potassium salt or a sodium salt) containing alkali metal ions having a larger ionic radius than alkali metal ions (e.g., sodium ions or lithium ions) contained in the glass, at a temperature not higher than the transition temperature of the glass.

Ion exchange is conducted between alkali metal ions contained in the glass and alkali metal ions of the alkali metal salt, which have a large ionic radius, to generate compressive stress in the glass surfaces on the basis of a difference in the volume occupied by the alkali metal ions, thereby forming the compressive stress layers 25 and 32. The temperature at which the glass is brought into contact with the molten salt may be any of temperatures not higher than the transition temperature of the glass, but is preferably lower than the glass transition temperature by at least 50° C. Use of such temperatures can prevent the glass from suffering stress relaxation.

In the chemical strengthening treatment, the treatment temperature at which the glass is brought into contact with the molten salt containing alkali metal ions and the time period of the contact can be suitably regulated in accordance with the compositions of the glass and molten salt. The temperature of the molten salt is usually preferably 350° C. or higher, more preferably 370° C. or higher, and is usually preferably 500° C. or lower, more preferably 450° C. or lower

By regulating the temperature of the molten salt to 350° C. or higher, the glass is prevented from being insufficiently chemically strengthened due to a decrease in ion exchange rate. By regulating the temperature of the molten salt to 500° C. or lower, the molten salt can be inhibited from decomposing or deteriorating.

The time period over which the glass is kept in contact with the molten salt, per treatment, is usually preferably 10 minutes or longer, more preferably 15 minutes or longer, from the standpoint of imparting sufficient compressive stress. Meanwhile, since prolonged ion exchange results not only in a decrease in production efficiency but also in a decrease in compressive stress due to relaxation, the time period over which the glass is kept in contact with the molten salt, per treatment, is usually 20 hours or less, preferably 16 hours or less.

The number of chemical strengthening treatments in the examples shown above was once or twice. However, the number thereof is not particularly limited so long as the desired properties (DOL, CS, and CT) of the compressive stress layers and tensile stress layer are obtained. Three or more strengthening treatments may be performed. A heat treatment step may be conducted between two strengthening treatments. In the following explanation, the case where three chemical strengthening treatments are performed and the case where a heat treatment step is conducted between two strengthening treatments are called three-stage strengthening.

Three-stage strengthening can be carried out, for example, by strengthening treatment method 1 or strengthening treatment method 2, which is explained below.

(Strengthening Treatment Method 1)

In strengthening treatment method 1, an LiO₂-containing glass for chemical strengthening is first brought into contact with a metal salt (first metal salt) containing sodium (Na) ions to cause ion exchange between Na ions in the metal salt and Li ions in the glass. Hereinafter, this ion exchange treatment is sometimes called “first-stage treatment”.

The first-stage treatment is conducted, for example, by immersing the glass for chemical strengthening in an Na-ion-containing metal salt (e.g., sodium nitrate) having a temperature of about 350° C. to 500° C. for about 0.1 hours to 24 hours. From the standpoint of improving the production efficiency, the period of the first-stage treatment is preferably 12 hours or less, more preferably 6 hours or less.

By the first-stage treatment, a deep compressive stress layer is formed in the glass surfaces. Thus, a stress profile having a CS of 200 MPa or larger and a DOL not less than ⅛ the sheet thickness can be formed. The glass which has just undergone the first-stage treatment has a large CT and hence has high friability. However, since the friability is mitigated by the following treatments, the large CT in this stage is rather preferred. The CT of the glass which has undergone the first-stage treatment is preferably 90 MPa or larger, more preferably 100 MPa or larger, still more preferably 110 MPa or larger. This is because this glass comes to have compressive stress layers having an increased compressive stress.

The first metal salt is one or more alkali metal salts and contains Na ions in a largest amount among the alkali metal ions. The first metal salt may contain Li ions, but the proportion of Li ions to the number of moles of the alkali ions, which is taken as 100%, is preferably 2% or less, more preferably 1% or less, still more preferably 0.2% or less. Furthermore, the first metal salt may contain K ions. The proportion of K ions to the number of moles of the alkali ions contained in the first metal salt, which is taken as 100%, is preferably 20% or less, more preferably 5% or less.

Next, the glass which has undergone the first-stage treatment is brought into contact with a metal salt (second metal salt) containing lithium (Li) ions to cause ion exchange between Li ions in the metal salt and Na ions in the glass to thereby reduce the compressive stress of portions near the surface layer. This treatment is sometimes called “second-stage treatment”.

Specifically, the glass which has undergone the first-stage treatment is immersed for about 0.1 hours to 24 hours in a metal salt containing both Na and Li, for example, a mixed salt composed of sodium nitrate and lithium nitrate, which has a temperature of, for example, about 350° C. to 500° C. From the standpoint of improving the production efficiency, the period of the second-stage treatment is preferably 12 hours or less, more preferably 6 hours or less.

The glass which has undergone the second-stage treatment can have a reduced internal tensile stress and does not shatter upon breakage.

The second metal salt is alkali metal salts and preferably contains Na ions and Li ions as alkali metal ions. It is preferable that the second metal salt is nitrates. The proportion of the total number of moles of Na ions and Li ions to the number of moles of the alkali metal ions contained in the second metal salt, which is taken as 100%, is preferably 50% or higher, more preferably 70% or higher, still more preferably 80% or higher. By regulating the Na/Li molar ratio, a stress profile in a portion ranging from DOL/4 to DOL/2 can be controlled.

Optimal values of the Na/Li molar ratio of the second metal salt vary depending on the glass composition. However, the Na/Li molar ratio thereof is, for example, preferably 0.3 or larger, more preferably 0.5 or larger, still more preferably 1 or larger. From the standpoint of increasing the compressive stress of the compressive stress layers while keeping the CT small, the Na/Li molar ratio is preferably 100 or less, more preferably 60 or less, still more preferably 40 or less.

In the case where the second metal salt is a sodium nitrate/lithium nitrate mixed salt, the mass ratio of sodium nitrate to lithium nitrate is, for example, preferably from 25:75 to 99:1, more preferably from 50:50 to 98:2, still more preferably from 70:30 to 97:3.

Next, the glass which has undergone the second-stage treatment is brought into contact with a metal salt (third metal salt) containing potassium (K) ions to cause ion exchange between K ions in the metal salt and Na ions in the glass to thereby generate a large compressive stress in the glass surfaces. This ion exchange treatment is sometimes called “third-stage treatment”.

Specifically, the glass which has undergone the second-stage treatment is immersed, for about 0.1 hours to 10 hours, in a metal salt containing K ions (e.g., potassium nitrate) having a temperature of, for example, about 350° C.- to 500° C. By this process, a large compressive stress can be produced in a surface layer of the glass ranging from 0 to about 10 km.

The third-stage treatment enhances the compressive stress of only the shallow surface portion of the glass and exerts little influence on the inner portion. It is hence possible to produce a large compressive stress in the surface layer while keeping the internal tensile stress small.

The third metal salt is one or more alkali metal slats and may contain Li ions as alkali metal ions. However, the proportion of Li ions to the number of moles of the alkali metal ions contained in the third metal salt, which is taken as 100%, is preferably 2% or less, more preferably 1% or less, still more preferably 0.2% or less. Meanwhile, the content of Na ions is preferably 2% or less, more preferably 1% or less, still more preferably 0.2% or less.

In strengthening treatment method 1, the total period of the first-stage to third-stage treatments can be reduced to 24 hours or less. This method hence has high production efficiency and is preferred. The total period of the treatments is more preferably 15 hours or less, still more preferably 10 hours or less.

(Strengthening Treatment Method 2)

In strengthening treatment method 2, a first-stage treatment is first conducted in which an Li₂O-containing glass for chemical strengthening is brought into contact with a first metal salt, which contains sodium (Na) ions, to cause ion exchange between Na ions in the metal salt and Li ions in the glass.

The first-stage treatment is the same as in strengthening treatment method 1 and an explanation thereon is omitted.

Next, the glass which has undergone the first-stage treatment is heat-treated without being brought into contact with a metal salt. This treatment is called a second-stage treatment.

The second-stage treatment is conducted, for example, by holding the glass which has undergone the first-stage treatment, in the air at a temperature of 350° C. or higher for a certain time period. The holding temperature is a temperature which is not higher than the strain temperature of the glass for chemical strengthening and which is preferably not higher than the temperature higher by 10° C. than the first-stage treatment temperature, more preferably the same as the first-stage treatment temperature.

It is thought that this treatment thermally diffuses the alkali ions introduced into the glass surfaces in the first-stage treatment and thereby reduces the CT.

Next, the glass which has undergone the second-stage treatment is brought into contact with a third metal salt, which contains potassium (K) ions, to cause ion exchange between K ions in the metal salt and Na ions in the glass to thereby generate a large compressive stress in the glass surfaces. This ion exchange treatment is sometimes called “third-stage treatment”.

The third-stage treatment is the same as in strengthening treatment method 1 and an explanation thereon is omitted.

In strengthening treatment method 2, the total period of the first-stage to third-stage treatments can be reduced to 24 hours or less. This method hence has high production efficiency and is preferred. The total period of the treatments is more preferably 15 hours or less, still more preferably 10 hours or less.

In strengthening treatment method 1, a stress profile can be precisely controlled by regulating the composition of the second metal salt for use in the second-stage treatment or by regulating the treatment temperature.

In strengthening treatment method 2, the chemically strengthened glass 2 having excellent properties is obtained at low cost through relatively simple treatments.

Treatment conditions for each chemical strengthening treatment, including period and temperature, may be suitably selected while taking account of the properties and composition of the glass, the kind of the molten salt, etc.

The chemically strengthened glass 2 is produced in the manners described above.

Next, an anti-fingerprint treated layer 81 is formed on or above the first main surface 21 of the chemically strengthened glass 2 produced.

For forming the anti-fingerprint treated layer 81, use can be made, for example, of a vacuum deposition method (dry process) in which a fluorine-containing organic compound or the like is vaporized in a vacuum chamber and deposited on the surface of an antireflection layer; or a method (wet process) in which a fluorine-containing organic compound or the like is dissolved in an organic solvent so as to result in a given concentration and this solution is applied to the surface of an antireflection layer.

A suitable dry process can be selected from an ion-beam-assisted vapor deposition method, ion plating, sputtering, plasma CVD, etc. A suitable wet process can be selected from spin coating, dip coating, casting, slit coating, spraying, etc. Either a dry process or a wet process can be used. In the case of applying a solution by spray coating, the concentration of the solution is preferably 0.15 mass % or less, more preferably 0.1 mass % or less.

Examples of methods for forming a coating film of a fluorine-containing organosilicon compound include: a method in which a composition including a silane coupling agent having a perfluoroalkyl group or a fluoroalkyl group, e.g., a fluoroalkyl group containing a perfluoro(polyoxyalkylene) chain, is applied by spin coating, dip coating, casting, slit coating, spray coating, or the like and then heat-treated; and a vacuum deposition method in which a fluorine-containing organosilicon compound is vapor-deposited and then heat-treated.

It is preferable that the formation of a coating film of a fluorine-containing organosilicon compound by the vacuum deposition method is conducted using a film-forming composition containing a fluorine-containing hydrolyzable silicon compound.

The above is an explanation on an example of processes for producing the cover glass 1.

### [Effects of the Cover Glass]

The cover glass 1 is less apt to have surface defects attributable to P and is less apt to suffer local electrification due to surface defects, since the tensile stress layer 27 has a P₂O₅ content of 2 mol % or less (about 5 mass % or less). Because of this, the cover glass 1 is less apt to suffer frictional electrification even when fingers of the user, etc. come into contact with the surface. The cover glass 1, after having been incorporated into display devices, can prevent opacification due to electrostatic charges.

The tensile stress layer 27 of the cover glass 1 satisfies that A×B is 135 or larger when the total concentration of Li₂O, Na₂O, and K₂O, among the oxide components constituting the tensile stress layer 27, is A mol % and the concentration of Al₂O₃ among these is B mol %, or that C×D is 240 or larger when the total concentration of Li₂O, Na₂O, and K₂O, among the oxide components constituting the tensile stress layer, is C mass % and the concentration of Al₂O₃ among these is D mass %. Consequently, since the cover glass 1 contains at least a certain amount of Li₂O, Na₂O, and K₂O, which do not contribute to the formation of glass network and which have high mobility and combine with electrostatic charges to perform charge neutralization, the cover glass 1 is less apt to suffer frictional electrification even when fingers of the user, etc. come into contact with the surface. Because of this, the cover glass 1 is less apt to suffer frictional electrification even when fingers of the user, etc. come into contact with the surface, and can prevent opacification due to electrostatic charges after having been incorporated into display devices.

Furthermore, the cover glass 1 contains at least a certain amount of Al₂O₃ which contributes to network formation and which is close to Li₂O, Na₂O, and K₂O. Hence, Li₂O, Na₂O, and K₂O come into the network to enlarge the distance. Because of this, the Li₂O, Na₂O, and K₂O are more movable, and the cover glass 1 is less apt to suffer frictional electrification even when fingers of the user, etc. come into contact with the surface. Consequently, the cover glass 1 is less apt to suffer frictional electrification even when fingers of the user, etc. come into contact with the surface, and can prevent opacification due to electrostatic charges after having been incorporated into display devices.

The cover glass 1 is inhibited from being frictionally charged, by the properties of the chemically strengthened glass 2. There is hence no need of disposing an electroconductive layer for charge neutralization, and the cover glass 1 can prevent opacification without increasing the thickness of the display device or the number of steps for production.

The compressive stress layers 25 and 32 of the cover glass 1 each have a depth DOL of 20 μm or larger. Because of this, in the case where an external shock is given to the cover glass 1, a deformation due to the shock is less apt to be transmitted to the tensile stress layer, resulting in enhanced impact resistance.

In the case where the first main surface 21 of the cover glass 1 has an area of 18,000 mm² or larger and when the surface of the anti-fingerprint treated layer has a frictional electrification amount of 0 kV or less and −1.5 kV or more, then the cover glass 1, in which the first main surface 21 and the second main surface 22 each have an area as large as 18,000 mm² or above, is less apt to suffer frictional electrification even when fingers of the user, etc. come into contact with the surface. Because of this, the cover glass 1, after having been incorporated into display devices, can prevent opacification due to electrostatic charges. Such frictional electrification amounts are hence preferred.

In the case where the first main surface 21 of the cover glass 1 has an area of 26,000 mm² or larger and when the surface of the anti-fingerprint treated layer has a frictional electrification amount of 0 kV or less and −0.5 kV or more, then the cover glass 1, in which the first main surface 21 and the second main surface 22 each have an area as large as 26,000 mm² or above, is less apt to suffer frictional electrification even when fingers of the user, etc. come into contact with the surface. Because of this, the cover glass 1, after having been incorporated into display devices, can prevent opacification due to electrostatic charges. Such frictional electrification amounts are hence preferred.

### Modification Examples

The present invention is not limited to the embodiments only, and various improvements, design changes, and the like are possible within the gist of the invention. The specific procedures, structures, etc. for carrying out the present invention may be other structures, etc. so long as the object of the present invention can be achieved.

The shape of the chemically strengthened glass 2 is not limited to a sheet having flat surfaces only, and may be a sheet at least partly having a cured surface or a sheet having a recess. For example, the chemically strengthened glass 2 may be a bent glass such as that shown in FIG. 2. In the case where a bent glass is used, attachment of the cover glass 1 to a mating member does not result in a decrease in attachment accuracy even when the mating member has a bent shape.

The thickness of the chemically strengthened glass 2 is preferably 0.5 mm or larger. Use of the glass having a thickness of 0.5 mm or larger has an advantage in that a cover glass 1 combining high strength and a satisfactory feeling is obtained. The thickness thereof is more preferably 0.7 mm or larger. In the case of use in display devices for mounting on vehicles, it is preferable that the thickness of the chemically strengthened glass 2 is 1.1 mm or larger, from the standpoint of ensuring impact resistance which enables the cover glass 1 to withstand a head impact test. From the standpoints of weight reduction and ensuring touch panel sensitivity, the thickness thereof is preferably 5 mm or less, more preferably 3 mm or less.

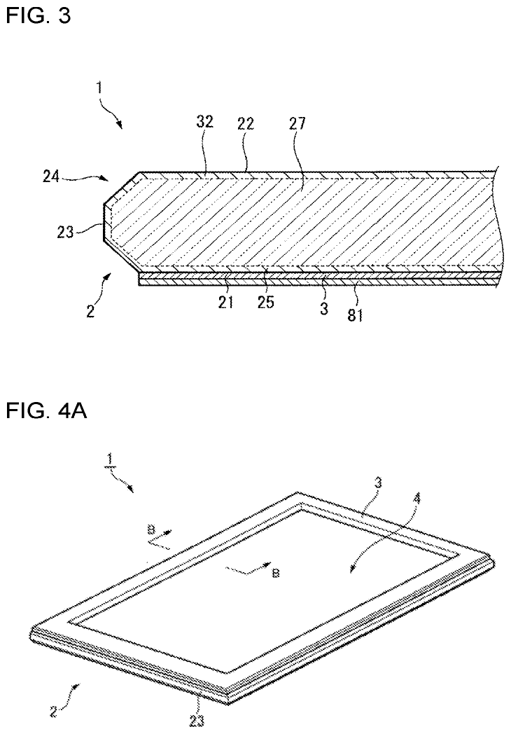

It is preferable that at least one of the first main surface 21 and the second main surface 22 of the chemically strengthened glass 2 is provided with at least one of an antiglare layer formed by an antiglare treatment (AG treatment) and an antireflection layer formed by an antireflection treatment (AR treatment), as a functional layer 3 as shown in FIG. 3.

In the case where the first main surface 21 is provided with an antiglare functional layer or an antireflection layer, it is preferable that at least one of the antiglare functional layer and the antireflection layer is disposed between the chemically strengthened glass 2 and the anti-fingerprint treated layer 81.

By disposing an antiglare layer as the functional layer 3, incident light entering from the first main surface 21 side can be scattered to diminish the reflection of incident light in the surface.

Examples of methods for imparting antiglare properties include a method in which surface irregularities are formed on the first main surface 21 of the chemically strengthened glass 2. An antiglare layer may be formed after chemical strengthening, or chemical strengthening treatments may be conducted after formation of an antiglare layer.

For forming the surface irregularities, known methods can be used. Use can be made of: a method in which the first main surface 21 of the chemically strengthened glass 2 is subjected to a chemical or physical surface treatment to form an etching layer and thereby forming surface irregularities having a desired surface roughness; or a method in which a coating layer, such as an antiglare film, is applied.

In the case where the antiglare layer is an etching layer, this is advantageous in that there is no need of separately coating the surface with an antiglare material. In the case where the antiglare functional layer is a coating layer, this is advantageous in that it is easy to control the antiglare properties by a material selection.

Examples of methods for chemically performing an antiglare treatment include a frosting treatment. The frosting treatment can be accomplished, for example, by immersing the glass substrate, as a glass to be treated, in a mixed solution of hydrogen fluoride and ammonium fluoride. As a method for physically performing an antiglare treatment, use can be made, for example, of: a sandblasting treatment in which a powder of crystalline silicon dioxide, a powder of silicon carbide, or the like is blown against the main surface of the glass substrate with compressed air; or a method in which the glass substrate surface is rubbed with a water-moistened brush to which a powder of crystalline silicon dioxide, a powder of silicon carbide, or the like has been adhered.

The surface of the antiglare layer preferably has a surface roughness (root mean square roughness, RMS) of 0.01 μm to 0.5 μm. The surface roughness (RMS) of the surface of the antiglare layer is more preferably 0.01 μm to 0.3 m, still more preferably 0.02 μm to 0.2 μm. By regulating the surface roughness (RMS) of the surface of the antiglare functional layer to a value within that range, the haze of the cover glass 1 can be regulated to 1% to 30%. Haze is a value defined by JIS K 7136 (2000).

By providing an antireflection layer as the functional layer 3 to the first main surface 21 side, light which has entered from the first main surface 21 side can be prevented from being reflected and the reflection of incident light in the surface can be prevented. Examples of the antireflection layer include the following.

(1) An antireflection layer having a multilayer structure formed by alternately laminating a low-refractive-index layer, which has a relatively low refractive index, and a high-refractive-index layer, which has a relatively high refractive index.

(2) An antireflection layer including a low-refractive-index layer which has a lower refractive index than the chemically strengthened glass 2.

The antireflection layer (1) preferably has a structure formed by laminating a high-refractive-index layer having a refractive index for light with 550-nm wavelength of 1.9 or higher and a low-refractive-index layer having a refractive index for light with 550-nm wavelength of 1.6 or less. The antireflection layer having such a structure formed by laminating a high-refractive-index layer and a low-refractive-index layer can more reliably prevent the reflection of visible light.

The antireflection layer (1) may be composed of one high-refractive-index layer and one low-refractive-index layer, or may be composed of two or more high-refractive-index layers and two or more low-refractive-index layers. In the case of the antireflection layer including one high-refractive-index layer and one low-refractive-index layer, this antireflection layer is preferably one formed by laminating the high-refractive-index layer and the low-refractive-index layer in this order on the first main surface 21 of the chemically strengthened glass 2. In the case of the antireflection layer including two or more high-refractive-index layers and two or more low-refractive-index layers, this antireflection layer is preferably a multilayer structure formed by alternately laminating the high-refractive-index layers and the low-refractive-index layers. The multilayer structure is preferably composed of two to eight laminated layers in total from the standpoint of production efficiency, and is more preferably composed of two to six laminated layers. One or more layers may be additionally formed so long as this addition does not lessen the optical properties. For example, an SiO₂ film may be interposed between the glass and the first layer in order to prevent the diffusion of Na from the glass sheet.

Materials for constituting the high-refractive-index layers and low-refractive-index layers are not particularly limited and can be selected while taking account of the required degree of antireflection properties and production efficiency. Examples of materials for constituting the high-refractive-index layers include niobium oxide (Nb₂O), titanium oxide (TiO₂), zirconium oxide (ZrO₂), tantalum oxide (Ta₂O₅), and silicon nitride (SiN). One or more materials selected from these can be advantageously used. Examples of materials for constituting the low-refractive-index layers include silicon oxides (in particular, silicon dioxide SiO₂), aluminum oxide (Al₂O₃), magnesium fluoride (MgF₂), materials including a mixed oxide of Si and Sn, materials including a mixed oxide of Si and Zr, and materials including a mixed oxide of Si and Al. One or more materials selected from these can be advantageously used.

In the antireflection layer (2), the refractive index of the low-refractive-index layer is set in accordance with the refractive index of the chemically strengthened glass, and is preferably 1.1 to 1.5, more preferably 1.1 to 1.4.

Methods suitable for forming the antireflection layer (2) are: a method in which an inorganic thin film is directly formed on the surface; a method in which the surface is treated by a technique such as, for example, etching; and dry processes, e.g., chemical vapor deposition (CVD) and physical vapor deposition (PVD), in particular, vacuum vapor deposition and sputtering, which are methods of physical vapor deposition.

The thickness of the antireflection layer is preferably 90 to 500 nm. By regulating the thickness of the antireflection layer to 90 nm or larger, the reflection of external light can be effectively inhibited. Such thicknesses are hence preferred.

It is preferable that the antireflection layer has a film configuration regulated so that the cover glass including the film gives reflected light having a color that is represented by a CIE (International Illumination Commission) color difference formula in which a* is −6 to 1 and b* is −8 to 1.

In the case where the antireflection layer gives a value of a* of −6 to 1 and a value of b* of −8 to 1, there is no possibility that the antireflection layer might have a hazard color (warning color), and the antireflection layer can be prevented from having a noticeable color.

In the case where an antireflection layer and an anti-fingerprint treated layer have been formed directly on the glass without forming an antiglare layer, this cover glass 1 is preferably one in which the surface of the antireflection layer, after the anti-fingerprint treated layer is removed by a corona treatment or a plasma treatment, has a surface roughness Ra of less than 1 nm. So long as the surface has a contact angle with water of about 200 or less, it can be deemed that the anti-fingerprint treated layer has been removed. In the case where the surface roughness Ra, after the removal of the outermost anti-fingerprint treated layer, is less than 1 nm, high resistance to abrasion and scratch can be attained. The surface roughness Ra is more preferably 0.3 nm to 0.6 nm, especially preferably 0.3 nm to 0.5 nm.

The surface roughness Ra can be measured, for example, with a scanning probe microscope SPI 3800N, manufactured by Seiko Instruments Inc., in the DFM mode.

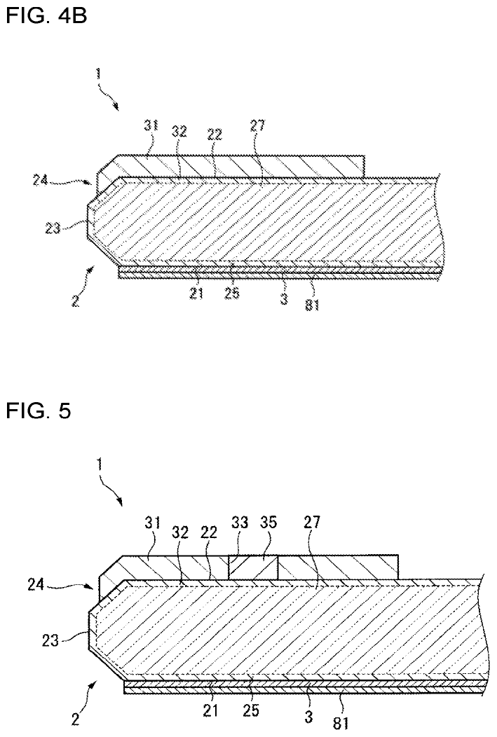

As shown in FIG. 4B, the cover glass 1 may include a light-shielding layer 31 provided on the second main surface 22. The light-shielding layer 31 is a layer which blocks visible light, specifically, a layer having a luminous transmittance for light with wavelengths of, for example, 380 nm to 780 nm of 50% or less. The disposition of the light-shielding layer 31 makes it possible to hide wiring lines disposed on the display device side and to hide the illuminating light of the backlight and prevent the illuminating light from leaking through the periphery of the display device.

Those portions of the second main surface 22 and chamfer 24 on which the light-shielding layer 31 is to be disposed may have undergone a primer treatment, an etching treatment, or the like in order to improve adhesion to the light-shielding layer 31.

Methods for forming the light-shielding layer 31 are not particularly limited. Examples thereof include methods in which the layer is formed by printing an ink by bar coating, reverse coating, gravure coating, die coating, roll coating, screen printing, ink-jet printing, etc. Screen printing is preferred from the standpoint of ease of thickness regulation.

The ink to be used for forming the light-shielding layer 31 may be either inorganic or organic. The inorganic ink may be, for example, a composition including: one or more oxides selected from SiO₂, ZnO, B₂O₃, Bi₂O₃, Li₂, Na₂O, and K₂O; one or more oxides selected from CuO, Al₂O₃, ZrO₂, SnO₂, and CeO₂; Fe₂O₃; and TiO₂.

As the organic ink, use can be made of any of various printing materials obtained by dissolving a resin in a solvent. For example, as the resin, use may be made of at least one resin selected from the group consisting of acrylic resins, urethane resins, epoxy resins, polyester resins, polyamide resins, vinyl acetate resins, phenolic resins, olefins, ethylene/vinyl acetate copolymer resins, poly (vinyl acetal) resins, natural rubber, styrene/butadiene copolymers, acrylonitrile/butadiene copolymers, polyester polyols, polyether-polyurethane polyols, and the like. As the solvent, use may be made of any of water, alcohols, esters, ketones, aromatic hydrocarbon solvents, and aliphatic hydrocarbon solvents. For example, usable as alcohols are isopropyl alcohol, methanol, ethanol, etc. Usable as an ester is ethyl acetate. Usable as a ketone is methyl ethyl ketone. Usable as aromatic hydrocarbon solvents are toluene, xylene, SOLVESSO (registered trademark) 100, SOLVESSO (registered trademark) 150, etc. Usable as aliphatic hydrocarbon solvents are hexane, etc. These were mentioned as examples, and various other printing materials can be used. Such an organic printing material is applied to the chemically strengthened glass 2 and the solvent is thereafter vaporized. Thus, a resinous light-shielding layer 31 can be formed. The ink to be used for forming the light-shielding layer 31 is not particularly limited and may be either a heat-curable ink, which can be cured by heating, or a UV-curable ink.

The ink to be used for forming the light-shielding layer 31 may contain a colorant. A black colorant such as carbon black can be used as the colorant in the case of forming, for example, a black light-shielding layer 31. Any of other colorants of appropriate colors can be used in accordance with desired colors.

The light-shielding layer 31 may be composed of a desired number of laminated layers, and different inks may be printed for forming the respective layers. The light-shielding layer 31 may be formed by printing not only on the second main surface 22 but also on the first main surface 21 and on edge surfaces 23.

In the case where the light-shielding layer 31 is formed by laminating a desired number of layers, different inks may be used for the respective layers. For example, in the case where the light-shielding layer 31 is desired to appear to be white when the user views the cover glass 1 from the first main surface 21 side, then use may be made of a method in which a first layer is formed by printing a white ink and a second layer is subsequently formed by printing a black ink. Thus, a white light-shielding layer 31 reduced in the so-called “show-through” can be formed, the show-through relating to the visibility of objects lying on the back side of the light-shielding layer 31 when the user views the light-shielding layer 31 from the first main surface 21 side.

The plan-view shape of the light-shielding layer 31 in FIG. 4A is a frame shape, and the inside of the frame is a display region 4. However, the shape of the light-shielding layer 31 need not be a frame shape and may be a linear shape extending along one edge of the second main surface 22, or an L shape lying along adjoining two edges thereof, or two linear shapes extending along opposed edges thereof. In the case where the second main surface 22 has a polygonal shape other than quadrilaterals or has a circular or unusual shape, the light-shielding layer 31 may have a frame shape, a linear shape extending along one edge of the polygonal shape, or a circular arc shape extending along some of the circular shape, in accordance with the shape of the second main surface 22.

In the case where the cover glass 1 is to be used in a display device, the light-shielding layer 31 preferably has a color according to the color of the display device in the non-display state. For example, in the case where the display device in the non-display state has a blackish color, it is desirable that the light-shielding layer 31 also has a blackish color.

In the case where the cover glass 1 includes the light-shielding layer 31, the light-shielding layer 31 may have an opening 33 as shown in FIG. 5 and it is preferable that an infrared-transmitting layer 35 having a higher infrared transmittance than the light-shielding layer 31 is provided to the opening 33. Forming the opening 33 in some of the light-shielding layer 31 and disposing the infrared-transmitting layer 35 makes it possible to dispose an infrared sensor on the back side of the light-shielding layer 31 and render the infrared-transmitting layer 35 unnoticeable.

Either an inorganic ink or an organic ink may be used for forming the infrared-transmitting layer 35. The inorganic ink may contain a pigment which is a composition including: one or more oxides selected from SiO₂, ZnO, B₂O₃, Bi₂O₃, Li₂O, Na₂O, and K₂O; one or more oxides selected from CuO, Al₂O₃, ZrO₂, SnO₂, and CeO₂; Fe₂O₃; and TiO₂.

As the organic ink, use can be made of any of various printing materials obtained by dissolving a resin and a pigment in a solvent. For example, as the resin, use may be made of at least one resin selected from the group consisting of acrylic resins, urethane resins, epoxy resins, polyester resins, polyamide resins, vinyl acetate resins, phenolic resins, olefins, ethylene/vinyl acetate copolymer resins, poly (vinyl acetal) resins, natural rubber, styrene/butadiene copolymers, acrylonitrile/butadiene copolymers, polyester polyols, polyether-polyurethane polyols, and the like. As the solvent, use may be made of any of water, alcohols, esters, ketones, aromatic hydrocarbon solvents, and aliphatic hydrocarbon solvents. For example, usable as alcohols are isopropyl alcohol, methanol, ethanol, etc. Usable as an ester is ethyl acetate. Usable as a ketone is methyl ethyl ketone. Usable as aromatic hydrocarbon solvents are toluene, xylene, SOLVESSO (registered trademark) 100, SOLVESSO (registered trademark) 150, etc. Usable as aliphatic hydrocarbon solvents are hexane, etc. These were mentioned as examples, and various other printing materials can be used. Such an organic printing material is applied to the chemically strengthened glass 2 and the solvent is thereafter vaporized. Thus, a resinous infrared-transmitting layer 35 can be formed. The ink to be used for forming the infrared-transmitting layer 35 is not particularly limited and may be either a heat-curable ink, which can be cured by heating, or a UV-curable ink.

The ink to be used for forming the infrared-transmitting layer 35 may contain a pigment. A black pigment such as carbon black can be used as the pigment in the case of forming, for example, a black infrared-transmitting layer 35. Any of other pigments of appropriate colors can be used in accordance with desired colors.

The content of the pigment in the infrared-transmitting layer 35 can be changed at will in accordance with desired optical properties. The content of the pigment, which is the ratio of the amount of the contained pigment to the mass of the whole infrared-transmitting layer 35, is preferably 0.01 to 10 mass %. Such a content can be attained by regulating the proportion of the content of the infrared-transmitting material to the overall mass of the ink.

The ink for forming the infrared-transmitting layer 35 includes a photocurable or heat-curable resin and a pigment having infrared-transmitting ability. As the pigment, either an inorganic pigment or an organic pigment is usable. Examples of the inorganic pigment include iron oxide, titanium oxide, and composite oxides. Examples of the organic pigment include metal complex pigments such as phthalocyanine pigments, anthraquinone pigments, and azo pigments. It is preferable that the infrared-transmitting layer 35 has the same color as the light-shielding layer 31. In the case where the light-shielding layer 31 is black, it is preferable that the infrared-transmitting layer 35 also is black.

Methods for forming the infrared-transmitting layer 35 are not particularly limited. Examples thereof include bar coating, reverse coating, gravure coating, die coating, roll coating, screen printing, and ink-jet printing. In view of the continuity of production, it is preferred to use the same layer-formation method as for the light-shielding layer 31.

The cover glass 1 of the present invention is usable as cover members for display devices such as panel displays, e.g., liquid-crystal displays, information appliances for mounting on vehicles, and portable appliances. By using the cover glass 1 of the present invention as the cover of a display device, the members to be protected can be protected and the touch sensor can be prevented from being opacified when used.

Furthermore, the cover glass 1 of the present invention has an advantage in that when the laminate applied to a surface of the cover glass is peeled off, for example, in bonding the cover glass to a panel in the production of a panel display, e.g., a liquid-crystal display or an organic EL display, an information appliance for mounting on vehicles, or a portable appliance, then the cover glass is inhibited from being charged and, hence, the adhesion of foreign matter thereto due to electrificaiton can be inhibited.

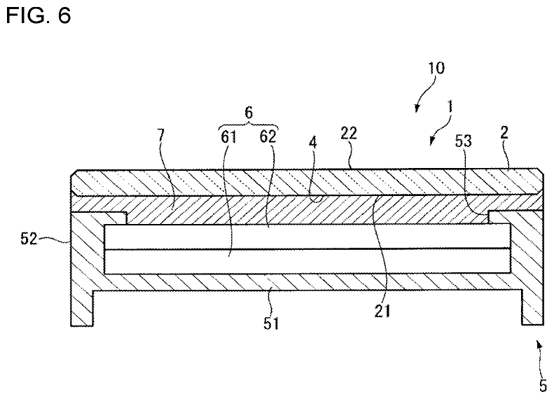

An example of display devices equipped with the cover glass 1 is explained below by reference to FIG. 6. Here, an in-cell IPS (in plane switching) liquid-crystal display device is shown as an example.

The display device 10 shown in FIG. 6 includes a frame 5. The frame 5 includes a bottom part 51, a sidewall part 52, which meets the bottom part 51, and an opening 53, which faces the bottom part 51. A liquid-crystal module 6 is disposed in the space surrounded by the bottom part 51 and the sidewall part 52. The liquid-crystal module 6 includes a backlight 61 disposed on the bottom part 51 side and a liquid-crystal panel 62 (display panel) disposed on the backlight 61. The liquid-crystal panel 62 includes an IPS liquid crystal and is of the in-cell type in which an element having a touch function is embedded in a liquid-crystal element.

The cover glass 1 is disposed on the upper end of the frame 5 so that the second main surface 22 faces the liquid-crystal module 6. The cover glass 1 is bonded to the frame 5 and the liquid-crystal module 6 via an adhesive layer 7 disposed on the upper end surfaces of the opening 53 and sidewall part 52.

It is preferable that the adhesive layer 7 is transparent and differs little in refractive index from the chemically strengthened glass 2.

Examples of the adhesive layer 7 include a transparent-resin layer obtained by curing a liquid curable resin composition. Examples of the curable resin composition include photocurable resin compositions and heat-curable resin compositions. Preferred of these is a photocurable resin composition including a curable compound and a photopolymerization initiator. The curable resin composition is applied using a method such as, for example, die coating or roll coating to form a film of the curable resin composition.

The adhesive layer 7 may be an OCA film (OCA tape). In this case, the OCA film may be applied to the second main surface 22 side of the cover glass 1.

The thickness of the adhesive layer 7 is preferably 5 μm to 400 μm, more preferably 50 μm to 200 μm. The adhesive layer 7 has a storage shear modulus of preferably 5 kPa or more and 5 MPa or less, more preferably 1 MPa or more and 5 MPa or less.

In producing the display device 10, the order of assembling is not particularly limited. For example, use may be made of a method in which a structure including the cover glass 1 and the adhesive layer 7 disposed thereon is prepared beforehand and is disposed on the frame 5 and the liquid-crystal module 6 is then bonded thereto.

### EXAMPLES

Next, Examples of the present invention are explained. The present invention is not limited to the following Examples.

Cover glasses having various properties were produced and examined for electrification amount and for the degree of opacification after having been incorporated into a device. The specific procedures are as follows. Examples 1 to 3 are working examples and Examples 4 and 5 are comparative examples.

### Example 1

First, a glass having the composition shown as Example 1 in Table 1 was produced by the float process to obtain a 0.7-mm glass sheet as a glass to be chemically strengthened. The glass obtained was cut into a size with a width of 100 mm and a length of 120 mm (area of the first main surface, 12,000 mm²), a size with a width of 100 mm and a length of 180 mm (area of the first main surface 21, 18,000 mm²), and a size with a width of 100 mm and a length of 260 mm (area of the first main surface 21, 26,000 mm²).

Next, these glasses were chemically strengthened. The chemical strengthening was conducted under the conditions of 8-hour immersion in 100 wt % molten potassium nitrate salt having a temperature of 420° C.

The strengthened glasses were cleaned. Thereafter, a liquid obtained by diluting A fluid S-550, manufactured by AGC Inc., with fluorochemical solvent ASAHIKLIN AC-6000, manufactured by AGC Inc., to 0.1 mass % was applied to one surface of each glass by spray coating to form an anti-fingerprint treated layer. Thus, cover glasses of Example 1 were obtained. The thickness of the anti-fingerprint treated layer was 5 nm.

In Examples 1 to 5 in Table 1, the total of the component contents (mol %, mass %) in each glass may not be 100. However, the total is a result of summing up rounded values and exerts no particular influence on calculating the concentrations mentioned in the claims.

The produced cover glasses of Example 1 were evaluated for the following properties.

<DOL, CS>

Each glass was examined for thickness-direction stress distribution using a glass surface stress meter (FSM-6000LE) manufactured by Orihara Industrial Co., Ltd. and measuring device SLP1000, manufactured by Orihara Industrial Co., Ltd., in which scattered-light photoelasticity was applied. The stress value of the outermost surface was taken as surface compressive stress CS. The depth of an inner portion of the glass at which the stress value had decreased to 0 MPa was taken as the depth of compressive stress DOL.

<CT>

CT was approximated using the relational expression CT=(CSDOL)/(t−2×DOL).

<Frictional Electrification Amount>

Frictional electrification amount was determined by the following four measuring methods.

Method 1: A frictional-electrification voltage attenuation measuring device (trade name, EST-8) manufactured by INTEC CO. LTD. was used to determine the frictional electrification amount by Method D described in JIS L1094:2014. (In Table 1, the determined amount is indicated by “JIS”.) The rubbing material was a cotton cloth.

Method 2: A static-charge visualization monitor (HSK-V5000B, manufactured by Hanwa Electrical Ind. Co., Ltd.) is disposed at a distance of 35 mm from a surface of a glass sample, the glass sample surface is rubbed with a cloth, and the resultant electrification amount is measured. As the cloth, unbleached muslin No. 3 was used. Six strips of the unbleached muslin were attached to a rectangular parallelepiped jig so that the cloth was in contact with the glass in an area of 20×20 mm, and the cloth was rubbed against the glass sample surface by reciprocating the jig thereon five times under a load of about 350 g. The cloth was rubbed over a distance of 4 cm at a speed of one reciprocation per second. Just after termination of the rubbing, the initial maximum electrification amount was measured. (In Table 1, the measured value is indicated by “Travel distance, 4 cm”.)

Method 3: In method 2, the distance over which the rubbing cloth in contact with the glass was moved was changed to 6 cm, the number of reciprocations of the rubbing material being 5. (In Table 1, the measured value is indicated by “Travel distance, 6 cm”.)

Method 4: In method 2, the distance over which the rubbing cloth in contact with the glass was moved was changed to 8 cm, the number of reciprocations of the rubbing material being 5. (In Table 1, the measured value is indicated by “Travel distance, 8 cm”.)

Method 5: In method 2, the distance over which the rubbing cloth in contact with the glass was moved was changed to 10 cm, the number of reciprocations of the rubbing material being 5. (In Table 1, the measured value is indicated by “Travel distance, 10 cm”.)

Method 6: In method 2, the distance over which the rubbing cloth in contact with the glass was moved was changed to 12 cm, the number of reciprocations of the rubbing material being 5. (In Table 1, the measured value is indicated by “Travel distance, 12 cm”.)

<Opacification>

The obtained cover glasses 1 were each incorporated into an in-cell IPS liquid-crystal display device. The display device was kept in the ON state, and the cover glass surface was touched with a finger, which was reciprocated ten times on the cover glass surface over a distance of 10 cm at a speed of one reciprocation per second. The display device was then visually examined for opacification. The cover glasses which caused opacification were indicated by “occurred” and those which caused no opacification were indicated by “not occurred”.

### Example 2

Raw materials were mixed so as to result in a glass having the composition shown as Example 2 in Table 1. The raw-material mixture was melted, poured so as to give a block about 300 mm square, and then gradually cooled to obtain a glass object as a glass to be chemically strengthened. Thereafter, the glass object was cut and machined to obtain plate-shaped glasses respectively having: a width of 100 mm, a length of 120 mm, and a thickness of 0.7 mm; a width of 100 mm, a length of 180 mm, and a thickness of 0.7 mm; and a width of 100 mm, a length of 260 mm, and a thickness of 0.7 mm.

Next, these glasses were chemically strengthened. The chemical strengthening was conducted under such conditions that the glasses were immersed for 3 hours in 100 wt % molten sodium nitrate salt having a temperature of 450° C. and then immersed for 3 hours in 100 wt % molten potassium nitrate salt having a temperature of 450° C.

Thereafter, the glasses were treated under the same conditions as in Example 1 to produce cover glasses of Example 2.

### Example 3

Cover glasses of Example 3 were produced under the same conditions as in Example 1, except that a glass having the composition shown as Example 3 in Table 1 was used as a glass to be chemically strengthened and that the chemical strengthening was conducted by 6-hour immersion in 100 wt % molten potassium nitrate salt having a temperature of 425° C.

### Example 4

Cover glasses of Example 4 were produced under the same conditions as in Example 1, except that a glass having the composition shown as Example 4 in Table 1 was used as a glass to be chemically strengthened and that the chemical strengthening was conducted by 6-hour immersion in 100 wt % molten potassium nitrate salt having a temperature of 425° C.

### Example 5

Cover glasses of Example 5 were produced under the same conditions as in Example 2, except that raw materials were mixed so as to result in a glass having the composition shown as Example 5 in Table 1 and the mixture was melted to obtain a glass block as a glass to be chemically strengthened and that the chemical strengthening was conducted by 2-hour immersion in 100 wt % molten sodium nitrate salt having a temperature of 450° C. and subsequent 1.5-hour immersion in 100 wt % molten potassium nitrate salt having a temperature of 425° C.

The results obtained by evaluating those cover glasses are shown in Table 1. (The numerical values given in Table 1 are ones for the cover glasses obtained by chemically strengthening the glasses which had undergone cutting and processing so as to have an area of 12,000 mm².)

TABLE 1

| Sample No. | | Ex. 1 | Ex. 2 | Ex. 3 | Ex. 4 | Ex. 5 |
|---|---|---|---|---|---|---|
| Composition | SiO₂ | 64.4 | 63.2 | 67.1 | 64.4 | 69.9 |
| (mol %) | B₂O₃ | — | — | 3.6 | — | — |
| | Al₂O₃ | 10.5 | 14.3 | 13.1 | 8 | 7.5 |
| | P₂O₅ | — | — | — | — | — |
| | Li₂O | — | 13.5 | — | — | 8 |
| | Na₂O | 16 | 2 | 13.7 | 12.5 | 5.3 |
| | K₂O | 0.6 | 5 | 0.1 | 4 | 1 |
| | MgO | 8.3 | 1 | 2.3 | 10.5 | 7 |
| | CaO | — | — | 0 | 0.1 | 0.2 |
| | SrO | — | — | — | 0.1 | — |
| | BaO | — | — | — | 0.1 | — |
| | ZnO | — | — | — | — | — |
| | ZrO₂ | 0.15 | 1 | — | 0.5 | 1 |
| | TiO₂ | 0.04 | — | — | — | 0.1 |
| | SnO₂ | — | — | 0 | — | — |
| Composition | SiO₂ | 60.9 | 59.2 | 61.2 | 60.9 | 69.3 |
| (mass %) | B₂O₃ | — | — | 3.8 | — | — |
| | Al₂O₃ | 16.8 | 22.7 | 20.4 | 12.8 | 12.7 |
| | P₂O₅ | — | — | — | — | — |
| | Li₂O | — | 6.3 | — | — | 3.95 |
| | Na₂O | 15.6 | 1.9 | 12.9 | 12.2 | 5.49 |
| | K₂O | 0.9 | 7.3 | 0.2 | 5.9 | 1.54 |
| | MgO | 5.3 | 0.6 | 1.4 | 6.7 | 4.69 |
| | CaO | 0.1 | — | 0 | 0.1 | 0.2 |
| | SrO | — | — | — | 0.2 | — |
| | BaO | — | — | — | 0.2 | — |
| | ZnO | — | — | — | — | — |
| | ZrO₂ | 0.3 | 1.9 | — | 1 | 1.96 |
| | TiO₂ | 0.05 | — | — | — | 0.17 |
| | SnO₂ | — | — | 0.1 | — | — |
| A = Total | mol % | 16.6 | 20.5 | 13.8 | 16.5 | 14.3 |
| alkaline | mass % | 16.5 | 15.5 | 13.1 | 18.1 | 10.98 |
| SiO₂ + B₂O₃ + | mol % | 74.9 | 77.5 | 83.8 | 72.4 | 77.4 |
| Al₂O₃ + P₂O₅ | mass % | 77.7 | 81.9 | 85.4 | 73.7 | 82 |
| A × B | mol % × mol % | 174.3 | 293.2 | 181 | 132 | 107.3 |
| C × D | mass % × mass % | 277.2 | 351.9 | 266.6 | 231.7 | 139.4 |
| DOL (μm) | | 40 | 135 | 45 | 49 | 145 |
| CS (MPa) | | 1060 | 880 | 875 | 880 | 910 |
| CT (MPa) | | 68 | 80 | 65 | 71 | 50 |
| Frictional | JIS | −0.44 | −0.6 | −0.31 | −5.93 | −6.1 |
| electrification | | | | | | |
| amount (kV) | | | | | | |
| Frictional | Friction distance, | −113 | −115 | −112 | −165 | −204 |
| electrification | 4 cm | | | | | |
| amount (V) | Friction distance, | −134 | −139 | −132 | −214 | −280 |
| | 6 cm | | | | | |
| | Friction distance, | −152 | −162 | −149 | −273 | −353 |
| | 8 cm | | | | | |
| | Friction distance, | −174 | −190 | −172 | −351 | −412 |
| | 10 cm | | | | | |
| | Friction distance, | −188 | −210 | −185 | −405 | −443 |
| | 12 cm | | | | | |

| | | | | | |
|---|---|---|---|---|---|
| Opacification | not | not | not | occurred | occurred |
| | occurred | occurred | occurred | | |

As shown in Table 1, Examples 1 to 3 each had a depth of compressive stress layer DOL of 20 μm or larger, a P₂O₅ content of 2 mol % or less (5 mass % or less), an A×B of 135 or larger (C×D of 240 or larger), and a frictional electrification amount by the JIS method of 0 kV or less and −1.5 kV or more and caused no opacification.

With respect to the frictional electrification amounts with travel distances of 4-12 cm, there was a tendency in each sample that the longer the distance, the larger the electrification amount. This indicates that displays having larger sizes, on which rubbing occurs over longer distances in actual use, are more apt to be charged and opacified.

Examples 4 and 5 each had an A×B less than 135, and hence had a frictional electrification amount by the JIS method less than −1.5 kV and caused opacification.

Examples 1 and 3 each had an A×B of 150 to 250 (C×D of about 250 to 300) and had a frictional electrification amount even smaller than in Example 2.

Examples 1 and 2 each had a total concentration of SiO₂, Al₂O₃, B₂O₃, and P₂O₅ of 81 mol % or less.

Examples 1 to 3 each had a CS of 800 MPa to 1,200 MPa and a CT of 60 MPa to 80 MPa.

It can be seen from these results that in the case where A×B was 135 or larger, this cover glass had a frictional electrification amount of 0 kV or less and −1.5 kV or more and was able to prevent opacification.

Moreover, the frictional electrification amounts measured with travel distances of 4 to 12 cm correlated with that measured by the JIS method. With respect to the frictional electrification amounts measured with travel distances of 4 to 12 cm, there was a tendency in each sample that the longer the distance, the larger the electrification amount. Although the cover glasses of Examples 1 to 3 in which the first main surfaces 21 had an area as large as 18,000 mm² or above or 26,000 mm² or above hence had large electrification amounts because of the long travel distances for a finger with which the cover glass surface was touched, these cover glasses were found to be less apt to cause opacification.

While the invention has been described in detail and with reference to specific embodiments thereof, it will be apparent to one skilled in the art that various changes and modifications can be made therein without departing from the spirit and scope thereof. This application is based on a Japanese patent application filed on Feb. 16, 2018 (Application No. 2018-26237), the entire contents thereof being incorporated herein by reference. All the references cited here are incorporated as a whole.

### REFERENCE SIGNS LIST

1 . . . cover glass, 2 . . . chemically strengthened glass, 3 . . . functional layer, 4 . . . display region, 5 . . . frame, 6 . . . liquid-crystal module, 7 . . . adhesive layer, 10 . . . display device, 21 . . . first main surface, 22 . . . second main surface, 23 . . . edge surface, 24 . . . chamfer, 25 . . . compressive stress layer, 27 . . . tensile stress layer, 31 . . . light-shielding layer, 32 . . . compressive stress layer, 33 . . . opening, 35 . . . infrared-transmitting layer, 51 . . . bottom part, 52 . . . sidewall part, 53 . . . opening, 61 . . . backlight, 62 . . . liquid-crystal panel, 81 . . . anti-fingerprint treated layer

1. A cover glass comprising: a chemically strengthened glass comprising a first main surface having an area of 12,000 mm² or larger and a second main surface; and an anti-fingerprint treated layer provided on or above the first main surface,
wherein the chemically strengthened glass has a depth of compressive stress layer DOL of 20 μm or larger, has a tensile stress layer having a P₂O₅ content of 2 mol % or less, and has A×B of 135 or larger, provided that, among oxide components constituting the tensile stress layer, a total concentration of Li₂O, Na₂O, and K₂O is A mol % and a concentration of Al₂O₃ is B mol %, and
the anti-fingerprint treated layer comprises a surface having a frictional electrification amount, as determined by Method D described in JIS L1094:2014, of 0 kV or less and −1.5 kV or more.

2. A cover glass comprising: a chemically strengthened glass comprising a first main surface having an area of 12,000 mm² or larger and a second main surface; and an anti-fingerprint treated layer provided on or above the first main surface,
wherein the chemically strengthened glass has a depth of compressive stress layer DOL of 20 μm or larger, has a tensile stress layer having a P₂O₅ content of 5 mass % or less, and has C×D of 240 or larger, provided that, among oxide components constituting the tensile stress layer, a total concentration of Li₂O, Na₂O, and K₂O is C mass % and a concentration of Al₂O₃ is D mass %, and
the anti-fingerprint treated layer comprises a surface having a frictional electrification amount, as determined by Method D described in JIS L1094:2014, of 0 kV or less and −1.5 kV or more.

3. The cover glass according to claim 1,
wherein the first main surface and the second main surface each have an area of 18,000 mm² or larger.

4. The cover glass according to claim 1,
wherein the first main surface and the second main surface each have an area of 26,000 mm² or larger, and
the surface of the anti-fingerprint treated layer has a frictional electrification amount, as determined by Method D described in JIS L1094:2014, of 0 kV or less and −0.5 kV or more.

5. The cover glass according to claim 1, further comprising at least one of an antiglare functional layer and an antireflection layer between the chemically strengthened glass and the anti-fingerprint treated layer.

6. The cover glass according to claim 1, comprising a light-shielding layer provided on or above the second main surface.

7. The cover glass according to claim 6,
wherein the light-shielding layer has an opening, and
an infrared-transmitting layer having a higher infrared transmittance than the light-shielding layer is provided to the opening.

8. The cover glass according to claim 1,
wherein the chemically strengthened glass is a bent glass.

9. An in-cell liquid-crystal display device comprising the cover glass according to claim 1.

10. The cover glass according to claim 2,
wherein the first main surface and the second main surface each have an area of 18,000 mm² or larger.

11. The cover glass according to claim 2,
wherein the first main surface and the second main surface each have an area of 26,000 mm² or larger, and
the surface of the anti-fingerprint treated layer has a frictional electrification amount, as determined by Method D described in JIS L1094:2014, of 0 kV or less and −0.5 kV or more.

12. An in-cell liquid-crystal display device comprising the cover glass according to claim 2.
